(19) United States
(12) Patent Application Publication
(10) Pub. No.: US 2005/0214193 A1
(43) Pub. Date: Sep. 29, 2005

(54) Nitric oxide purification method and apparatus

(76) Inventor: Luca D'Ottone, Key Biscayne, FL (US)

Correspondence Address: LUCA D'OTTONE, 251 GALEN DRIVE, 305E, KEY BISCAYNE, FL, 33149, US

(21) Appl. No.: 10/808,804

(22) Filed: Mar. 25, 2004

(51) Int. Cl. C01B 21/24

(52) U.S. Cl. 423/405

(57) ABSTRACT

Provided are a process and an apparatus for the purification of nitric oxide for industrial, analytical, and research purposes. Nitric Oxide (chemical formula NO) is also referred as nitrogen monoxide. It is a colorless gas having extremely high reactivity toward oxygen and other oxidants present in the atmosphere. The method to purify Nitric Oxide consists in passing a steady flow of a mixture of impure Nitric Oxide, optionally diluted in an inert gas, through a filter composed of hydroxides of alkali and earth alkali metal kept at a temperature below 298 K. The Nitric Oxide is then passed through a second filter and finally collected in a sealed container. The second step has the function to remove those impurities that may not have been removed in the first step.

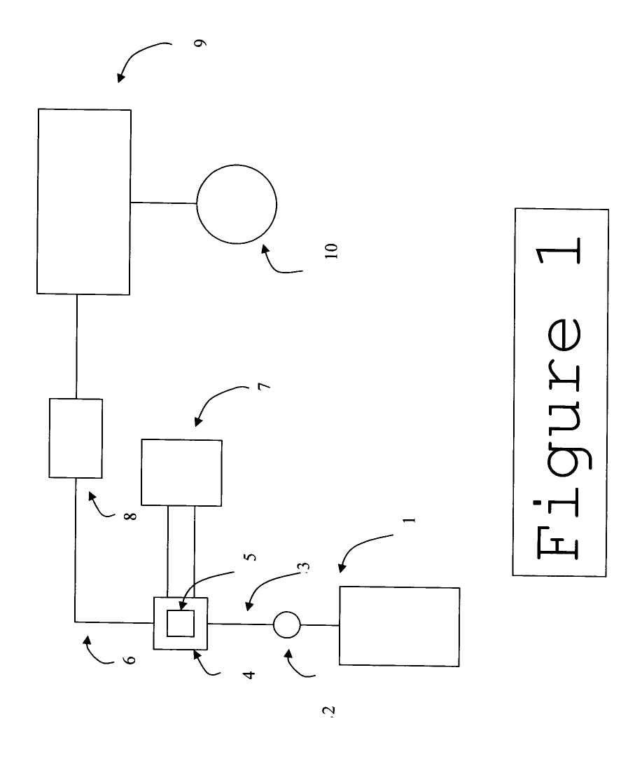

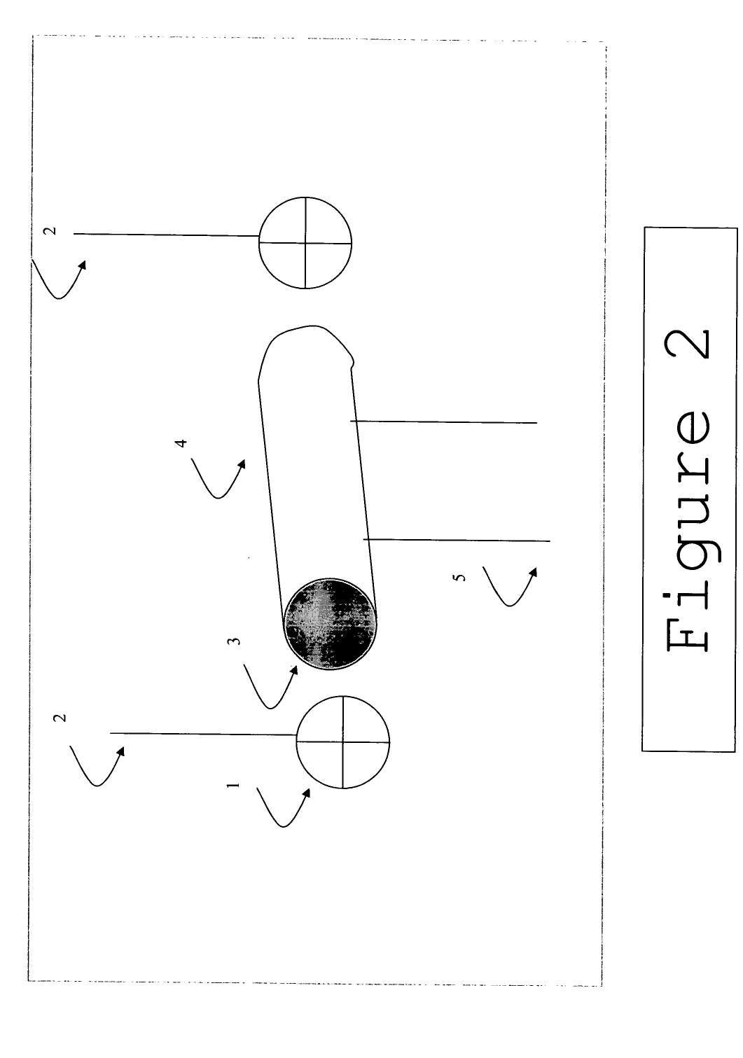

### BACKGROUND OF THE INVENTION

1. Field of the Invention

The present invention relates to a novel system for the purification of nitric oxide. The present invention also relates to a method of producing nitric oxide of ultra-high purity. The invention was developed to provide impurities free nitrogen monoxide for research purposes in a limited budged research laboratory. The process was found to be extremely effective and has potential for scale up.

2. Description of the Related Art

Nitric oxide is a colorless gas having extremely high reactivity toward atmospheric oxygen and other oxidant present in the atmosphere like the hydroxyl radical. NO reacts quickly with these oxidants becoming NO₂. NO finds a number of critical applications both in the pharmaceutical and in the semiconductor industry.

It is particularly important for nitric oxide to be of ultra high purity, on the order of 99.999% or greater purity. Such purity will ensure the absence of dangerous NO₂ in medical applications and limit the presence of other impurities like SO₂, SO₃, and CO₂ in nitrogen monoxide for industrial uses.

A number of U.S. patents deal with methods to purify nitric oxide: U.S. Pat. Nos. 5,670,125, 5,514,204, 5,417,950, 5,268,465. All of these methods use a zeolite filter to free nitrogen monoxide from impurities.

The main disadvantages of all these methods is that a zeolite filter is not something commercially or readily available in research labs, it is expensive, and must be changed due to chemical deterioration.

Another patented method to purify nitric oxide is U.S. Pat. No. 6,576,044, but it also suffer of the main disadvantage to require extensive equipment and/or specific chemicals.

The method, object of this application, allows the purification of nitric oxide for industrial and research purposes at little or moderate cost. It's easy to use and set up, and does not require expensive parts. It is particularly indicated for those applications where it is critical to remove acidic impurities like NO₂, SO₂, SO₃, and CO₂ from the gaseous mixture.

A further advantage associated with the novel system is that the total cost of purification can be significantly reduced by eliminating complicated secondary operations needed to eliminate carbon dioxide and light impurities like volatile organics.

It is a specific object of the invention to provide a process for the removal of acid gases from nitric oxide. In the past there have been some attempt to achieve this level of purity for research purposes but results using literature methods are not satisfactory. [Hughes, 1961]

A similar apparatus have been suggested to purify nitrous oxide (not nitric oxide) in the U.S. published application 20020056289. No reference is made in such application to the use of that apparatus for purifying nitric oxide.

Still another difference from U.S. published application 20020056289 is that we found effective the use of a mixture of hydroxides of alkali and earth alkali metals for the first filter, instead of the use of ASCARITE (registered trademark) only.

In addition to that it is a goal of this invention to eliminate N₂O as a potential impurity contained in the initial mixture. This invention achieves that by freezing out the N₂O in the first filter. In one of the possible embodiments of this invention the first filter is kept at the temperature around 150 K. At this temperature the nitrous oxide, having freezing point at 182.32 K, freezes on the wall of said first filter, while the nitric oxide, having freezing point at 109.54 K does not solidify and can flow to the second filter without being depleted. One optional feature of this invention is a specially designed filter net kept at a constant temperature to freeze out nitrous oxide and all other impurities having a condensation point higher than the one of nitric oxide.

Other objects and aspects of the present invention will become apparent to one of ordinary skill in the art on a review of the specification, and claims appended thereto.

### SUMMARY OF THE INVENTION

This invention consists in an innovative process and a novel apparatus for purification of nitric oxide. The invention finds particular applicability in the semiconductor manufacturing industry, in research applications, and in the medical industry.

The process for removal of impurities from a nitric oxide includes the steps of:
(a) providing a mixture of impure nitric oxide and, optionally, an inert gas in a purification tank;
(b) routing the impure nitric oxide trough a filter composed by a mixture of hydroxides of alkali and earth alkali metals kept at around 150 K.
(c) collecting the purified nitric oxide in a delivery tank.
(d) preventing the entrance of oxygen or other contaminants in the delivery tank.

In accordance with another aspect of the invention an apparatus for nitric oxide purification is provided. The system includes: (a) a tubing or plumbing system having its internal surface covered with an inert material; (b) two filter chambers having its internal surface covered with an inert material; (c) a first filter consisting of a mixture of hydroxides of alkali and earth alkali metals; (d) a second filter consisting of a molecular sieve; (e) a thermostatic chamber to keep constant the temperature of the filter chamber; (f) a temperature sensor to monitor the temperature of the filter chamber.

### DETAILED DESCRIPTION OF THE PREFERRED EMBODIMENTS OF THE INVENTION (i.e. DESCRIPTION OF THE DRAWINGS)

The invention provides an efficient and effective means of purifying a nitric oxide from common impurities like acid gases. The term acid gases as used herein is defined as carbon dioxide, nitrogen dioxide, sulfur dioxide, sulfur trioxide, and other acid gases known to the artisan skilled in the art.

The invention provides an efficient method to purify nitric oxide from compounds having a freezing point higher than 109.54 K.

The apparatus in claim fourteen can be described with reference to the FIG. (1) of drawing.

FIG. (1) Number (1) in the drawing: the delivery tank.

FIG. (1) Number (2) in the drawing: first tubing system internally coated with inert material.

FIG. (1) Number (3) in the drawing: a needle valve to regulate the gas flow trough the filter system.

FIG. (1) Number (4) in the drawing: thermostatic jacket around the first filter.

FIG. (1) Number (5) in the drawing: first filter: a filter chamber internally coated by inert material such as Teflon (registered trade mark), filled with a mixture of hydroxides of alkali and earth alkali metals.

FIG. (1) Number (6) in the drawing: second tubing system internally coated with an inert material.

FIG. (1) Number (7) in the drawing: thermostatic bath containing the refrigerant.

FIG. (1) Number (8) in the drawing: second filter: a filter chamber internally coated with an inert material filled with a molecular sieve.

FIG. (1) Number (9) in the drawing: a collection tank.

FIG. (1) Number (10) in the drawing: a vacuum pump.

FIG. (2) illustrates said first filter system, composed by a metal filter-net, a box internally covered by an inert material, an internal filter composed by a mixture of hydroxides of alkali and earth alkali metals, a support of silica dioxide.

FIG. (2) Number (1) in the drawing: metal filter-net.

FIG. (2) Number (2) in the drawing: connections to an external cooling system for the metal filter net.

FIG. (2) Number (3) in the drawing: internal filter system composed by a support of silica dioxide and having as an active component at least one hydroxide of alkali or earth alkali metals.

FIG. (2) Number (4) in the drawing: a box internally covered by an inert material such as Teflon (registered Trade mark), containing the filter material.

FIG. (2) Number (5) in the drawing: connections to an external cooling system for the filter box.

### EXAMPLE

A nitric oxide purification system as shown in the drawing was used to purify a mixture of nitric oxide in Helium. The mixture of impure nitric oxide (10%) in Helium (balance) is flushed from a delivery tank at above atmospheric pressure trough the first filter.

The first filter has two functions.

The first function of the first filter is to remove all the impurities from the flow of nitric oxide having freezing point above the freezing point of nitric oxide i.e. higher than 109.54 K. This is achieved by keeping the temperature of the filter as close as possible to 110 K. Such impurities include NH₃, N₂O, H₂O, hydrocarbons.

The second function is to eliminate all the acid impurities by neutralization on the filter composed by a mixture of hydroxides of alkali and earth alkali metals. Such impurities include CO₂, SO₂, SO₃, HNO₃, NO₂.

The first filter, once exhausted, cannot be regenerated and must be changed.

The nitric oxide is then passed through a second filter. The second filter is constituted by a commercial molecular sieve.

The nitric oxide is then collected in a collection tank.

The purity of the nitric oxide is checked by UV spectroscopy using an optical multi-channel analyzer (OMA). Nitric oxide has negligible cross section in the UV visible region of the electromagnetic spectrum.

The concentration of nitric oxide in the collection tank is estimated by titrating the nitric oxide with oxygen and comparing the recorded spectra with the absolute cross section of nitric dioxide.

The presence of impurities can also be monitored by a gas chromatography (GC) model VARIAN 3400 capable of detecting to as low as 0.01 part per million by volume (ppmv).

The invention can also function without the second filter, that is in fact optional.

While the invention has been described in detail with reference to a specific embodiment thereof, it will be apparent to one skilled in the art that various changes and modifications can be made, and equivalents employed without departing from the scope of the claims.

1. A process for removal of impurities from Nitric Oxide gas, for a research, industrial, semiconductors, medical, and analytical application, comprising: (a) providing a mixture of Nitric Oxide and its common impurities, (b) passing this gaseous mixture trough a first filter composed by a mixture of hydroxides of alkali and earth alkali metals, (c) passing the mixture through a second filter system, (d) collecting the purified gas in a sealed delivery tank.

2. The process for removal of impurities according to claim 1, further comprising: maintaining the temperature of said first filter between 50 and 298 degrees Kelvin.

3. The process for removal of light impurities according to claim 2, further comprising: maintaining a pressure between 0.1 and 1000 atmospheres inside said delivery tank.

4. The process for removal of impurities according to claim 1, further comprising: retaining impurities in said first filter and in said second filter.

5. The process for removal of impurities according to claim 1, wherein the impurities are selected from a group comprising nitrogen dioxide (NO₂), sulfur dioxide (SO₂), sulfur trioxide (SO₃), methane (CH₄), oxygen (O₂), carbon monoxide (CO), and carbon dioxide (CO₂), ozone (O₃), water (H₂O), ammonia (NH₃), nitrous oxide (N₂O) and volatile hydrocarbons.

6. The process for removal of impurities according to claim 1 where the mixture of hydroxides of alkali and earth alkali metal inside said filter 1 contains ASCARITE (registered trademark).

7. The process for removal of impurities from nitric oxide according to claim 1 where the mixture of hydroxides of alkali and earth alkali metals contains sodium hydroxide.

8. The process for removal of impurities from nitric oxide according to claim 1 where the mixture of hydroxides of alkali and earth alkali metals contains anyone of the following compounds: sodium hydroxide, barium hydroxide, calcium hydroxide, lithium hydroxide, magnesium hydroxide, potassium hydroxide, strontium hydroxide, cesium hydroxide, francium hydroxide, and silica dioxide.

9. The process for nitric oxide purification according to claim 1, wherein said mixture of hydroxides of alkali and earth alkali metals is replaced upon depletion.

10. The process for nitric oxide purification according to claim 1, wherein said second filter contains a molecular sieve.

11. The process for nitric oxide purification according to claim 1, wherein said second filter is regenerated by flushing a dry gas and by heat.

12. The process for nitric oxide purification according to claim 1, wherein said nitric oxide conveyed to said delivery tank has a percentage of impurities between 0% and 1%.

14. An apparatus for removing impurities from a nitric oxide comprising: (a) a tank of impure nitric oxide, said tank having a first end and a second end; (b) a first inert tubing system connecting said first end of said tank to a first filter-pack, (c) a needle valve to regulate the gas flow trough the filtering system, (d) a first filter-pack, (e) a second inert tubing system connecting said filter-pack to a second filter-pack, (f) a second filter-pack, (g) a third inert tubing system delivering the purified nitric oxide to a delivery tank, (h) a delivery tank.

15. The apparatus for removing impurities from a nitric oxide gas according to claim 14, further comprising: a refrigeration unit integral with or separate from said first filter in order to maintain said first filter at a temperature between 50 and 298 degrees Kelvin.

16. The apparatus for removing impurities from a nitric oxide gas according to claim 14, comprising a vacuum pump.

17. The apparatus for removing impurities from a nitric oxide gas according to claim 14, wherein said second filter pack is a molecular sieve.

18. The apparatus for nitric oxide purification, according to claim 14, wherein said first filter comprises silica dioxide supporting a hydroxide of an alkali or earth alkali metal.

19. The apparatus for removal of impurities according to claim 14, further comprising a tubing system internally coated with an inert material to avoid any reaction between the gas mixture and its internal surface. Said tubing system connecting all the elements of the apparatus.

20. An apparatus for filtering out impurities from nitric oxide comprising (a) a support of silica dioxide, (b) at least one hydroxide of alkali or earth alkali metals, (c) a box having inert interior surfaces and two openings, (d) a cooling system to cool down the temperature of the impure NO flow, (e) a metal filter-net to easy the deposition of the impurities.
